(19) United States
(12) Patent Application Publication
(10) Pub. No.: US 2017/0111257 A1
(43) Pub. Date: Apr. 20, 2017

(54) Event Responsive Support Device, Event Responsive Support Method and Program Thereof

(71) Applicant: Hitachi Systems, Ltd., Shinagawa-ku, Tokyo (JP)

(72) Inventor: Yuichi NOZAWA, Meguro-ku, Tokyo (JP)

(21) Appl. No.: 15/127,250

(22) PCT Filed: Mar. 20, 2014
(86) PCT No.: PCT/JP2014/057761

§ 371 Date: Sep. 19, 2016

(51) Int. Cl. H04L 12/26

(52) U.S. Cl. CPC H04L 43/18; H04L 43/065

(57) ABSTRACT

To support a user to be capable of more rapidly and accurately executing a response to an event occurring in a device. An event responsive support device specifies support information associated with log information of a monitoring target device from a support information storage unit, and acquires a responding method to the event associated with the log information from the specified support information. In addition, history information associated with the specified support information is specified from a history information storage unit, and complementary information with respect to the responding method is acquired from the specified history information. In addition, the acquired responding method and complementary information are output.

### TECHNICAL FIELD

The present invention relates to an event responsive support device, an event responsive support method, and a program thereof.

### BACKGROUND ART

Devices that configure a network system, for example, devices such as a server, a router, and a switch, include those capable of detecting an event such as failure and trouble occurred in the own device and recording the event as log information. In addition, these devices are capable of sending the recorded log information to an external monitoring terminal and the like. The monitoring terminal is capable of, for example, displaying the received log information and the like or giving notice to a user of the network system. The user can determine a responding method (may be referred to also as a “coping method”) such as a solving means with respect to the event occurred by, for example, confirming the log information and the like d splayed on the monitoring terminal.

For example, Patent Literature 1 describes a system that manages failure using a simple network management protocol (SNMP) or a management information base (MIB).

### CITATION LIST

### Patent Literature

Patent Literature 1: JP 2000-115168 A

### SUMMARY OF INVENTION

### Technical Problem

Meanwhile, when the user determines the responding method with respect to the event occurred as described above, the responding method thus determined is affected by, for example, the user's technical capability or experience. Thus, there is a case in which the responding method which is not suitable is determined and it is difficult to suitably respond to the event. In addition, in some cases, it is necessary to analyze the log information or investigate a product manual in order to determine the responding method so that it is difficult to rapidly solve the problem. In addition, when the event is complex, there is a case in which the accuracy of response decreases or a period for solving tie problem increases

Thus, the present invention aims to support a user to be capable of more rapidly and accurately executing a response to an event occurring in a device.

### Solution to Problem

The present application includes a plurality of means for solving at least some of the above-described problems, and examples thereof may be given as follows.

A first aspect of the present invention, which is configured to solve the above-described problems, is an event responsive support device that supports a response to an event occurring in a monitoring target device, the device which is characterized by including: a support information storage unit in which information to specify information and support information including a responding method to an event associated with the log information are stored; a history information storage unit in which history of the responding method of the support information that has been output for each of the support information and history information including complementary information with respect to the responding method of the support information in the history are stored in association with each other; a monitoring unit which monitors log information of the monitoring target device; and an output unit which specifies support information, associated with the log information of the monitoring target device received from the monitoring unit, from the support information storage unit and acquires the responding method from the specified support information, specifies history information, associated with the specified support information, from the history information storage unit and acquires the complementary information from the specified hi story information, and outputs the acquired responding method and complementary information.

Here, the event responsive support device may be characterized by including: a generation unit which adds history information to the history information storage unit when the support information associated with the log information of the monitoring target device is specified by the output unit, and associates the history information with the specified support information; and an input unit which receives input of information to set the complementary information of the history information added by the generation unit, and sets the information to the complementary information.

In addition, the event responsive support device may be characterized that the generation unit adds support information to the support information storage unit when the support information associated with the log information of the monitoring target device is not specified by the output unit, and sets information to specify the is information of the monitoring target device to the support information, and the input unit receives input of information, which is set to a responding method of the support information added by the generation unit, and sets the responding method.

In addition, the event responsive support device may be characterized that the input unit receives approval with respect to the support information or the history information added to the support information storage unit or the history information storage unit by the generation unit, and the output unit output the responding method of the approved support information or the complementary information of the approved history information.

In addition, the event responsive support device may be characterized by further including a reliability information storage unit in which reliability information indicating reliability of the support in is stored in association with each of the support information stored in the support information storage unit, in which the output unit acquires reliability information associated with the specified support information from the reliability information storage unit, and outputs the acquired reliability information together with the responding method.

In addition, the event responsive support device may be characterized by further including a reliability calculation unit which calculates the reliability of the support information based on the number of history information associated with the support information, and sets the calculated reliability to the reliability information stored in the reliability information storage unit.

In addition, the event responsive support device may be characterized that the output unit determines whether the reliability of the support information is equal to or lower than a predetermined threshold, and outputs a message to encourage a review the support information having the reliability equal to or lower than the predetermined threshold.

In addition, the event responsive support device may be characterized by further including a difficulty information storage unit in which difficulty information indicating a difficulty of the responding method of the support information is stored in association with each of the support information stored in the support information storage unit, in which the output unit acquires difficulty information associated with the specified support information from the difficulty information storage unit, and outputs the acquired difficulty information together with the responding method.

In addition, the event responsive support device may be characterized by further including a level information storage unit in which level information indicating a response ability level of a user is stored in association with each of the users, in which the output unit acquires level information of a user as an output destination of the responding method from the level information storage unit, and determines and outputs advice content based on the acquired difficulty information and level information.

In addition, the event responsive support device may be characterized by further including an urgency information storage unit in which urgency information indicating urgency of a response to an event based on the support information is stored in association with each of the support information stored in the support information storage unit, in which the output unit acquires urgency information associated with the specified support information from the urgency information storage unit, and outputs the acquired urgency information together with the responding method.

A second aspect of the present invention, which is configured to solve the above-described problems, is an event responsive support method in an event responsive support device that supports a response to an event occurring in a monitoring target device, the event responsive support device including: a support information storage unit in which information to specify log information and support information including a responding method to an event associated with the log information are stored; and a history information storage unit in which history of the responding method of the support information that has been output for each of the support information and history information including complementary information with respect to the responding method of the support information in the history are stored in association with each other, the event responsive support method is characterized by including: a monitoring step of monitoring log information of the monitoring target device; and an output step of specifying support information, associated with the log information of the monitoring target device received in the monitoring step, from the support information storage unit and acquiring the responding method from the specified support information, specifying history information, associated with the specified support information from the history information storage unit and acquiring the complementary information from the specified history information, and outputting the acquired responding method and complementary information.

A third aspect of the present invention, which is configured to solve The above-described problems, is a program that causes a computer to function as an event responsive support device that supports a response to an event occurring in a monitoring target device, the program is characterized by causing the computer to serve as: a support information storage unit in which information to specify log information and support information including a responding method to an event associated with the log information are stored; a history information storage unit, in which history of the responding method of the support information that has been output for each of the support information and history information including complementary information with respect to the responding method of the support information in the history are stored in association with each other; a monitoring unit which monitors log information of the monitoring target device; and an output unit which specifies support information, associated with the log information of the monitoring target device received from the monitoring unit, from the support information storage unit and acquires the responding method from the specified support information, specifies history information, associated with the specified support information, from the history information storage unit and acquires the complementary information from the specified history information, and outputs the acquired responding method and complementary information.

### BRIEF DESCRIPTION OF DRAWINGS

FIG. 1 is a diagram illustrating an example of a schematic configuration of a network system 10 according to a first embodiment of the present invention.

FIG. 2 is a diagram illustrating an example of a functional configuration of an event responsive support device 1.

FIG. 3 is a diagram illustrating an example of a configuration of a support information table 111.

FIG. 4 is a diagram illustrating an example of a configuration of a history information table 112.

FIG. 5 is a diagram illustrating an example of a schematic configuration of a computer 40.

FIG. 6 is a flowchart illustrating an example or a support information output process.

FIG. 7 is a diagram illustrating an example of a UI screen 50 that outputs support information.

FIG. 8 is a flowchart illustrating an example of a support information registration process.

FIG. 9 is a flowchart illustrating an example of a support information approval process.

FIG. 10 is a flowchart illustrating an example of a support information search process and a support information edit process.

FIG. 11 is a diagram illustrating an example of a UI screen 60 to which an operation with respect to the support information is input.

FIG. 12 is a diagram illustrating an example of a functional configuration of an event responsive support device 1A according to a first modification example.

FIG. 13 is a diagram illustrating an example of a configuration of a reliability information table 113.

FIG. 14 is a diagram illustrating an example of a UI screen 50A that outputs reliability.

FIG. 15 is a flowchart illustrating an example of a reliability calculating process.

FIG. 16 is a diagram illustrating an example of a functional configuration of an event responsive support device 1B according to a second modification example.

FIG. 17 is a diagram illustrating an example of a configuration of a difficulty information table 114.

FIG. 18 is a diagram illustrating an example of a configuration of a user level information table 115.

FIG. 19 is a diagram illustrating an example of a UI screen 50B that outputs a difficulty.

FIG. 20 is a diagram illustrating an example of a functional configuration of an event responsive support device 10 according to a third modification example.

FIG. 21 is a diagram illustrating an example of a configuration of an urgency information table 116.

FIG. 22 is a diagram illustrating an example of a UI screen 50C that outputs urgency.

### DESCRIPTION OF EMBODIMENTS

### First Embodiment

A first embodiment of the present invention will be described with reference to the drawings.

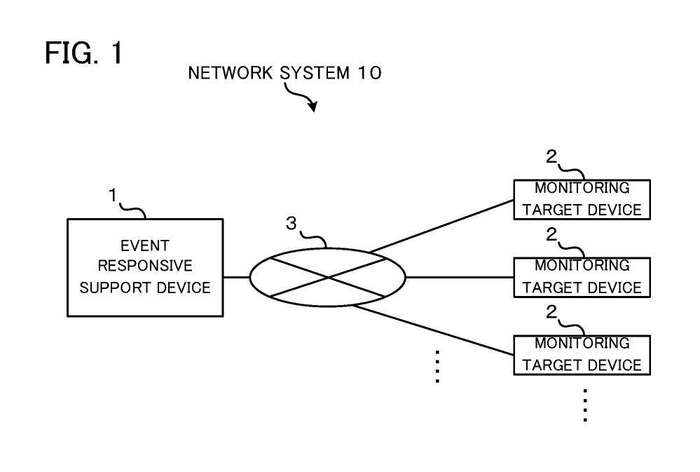

FIG. 1 is a FIG. 1 is a diagram illustrating an example of a schematic configuration of a network system 10 according to a first embodiment of the present invention. The network system 10 includes an event responsive support device 1 and one or more monitoring target devices 2. The event responsive support device 1 and the monitoring target device 2 are connected to each other via a network. 3, for example, a local area network (LAN), the internet or the like.

The event responsive support device 1 monitors and receives log information sent from the monitoring target device 2, and displays a responding method or the like in relation to an event such as failure and trouble that is specified from the log information. The event responsive support device 1 may be referred to also as a network monitoring device, a network monitoring server, a network monitoring system, or the like. The event responsive support device 1 will be described later in detail.

The monitoring target device 2 is a device, for example, a server device, a router, a switch, a user terminal, or the like. The monitoring target device has a function of recording the log information in relation to the event occurred in the own device or another device. In addition, the monitoring target device 2 has a function of sending the recorded log information to an external device, and is set to send the log information to the event responsive support device 1 in the present embodiment.

Incidentally, the log information includes, for example, an event log, an error log, and the like of an operating system (OS) or a system. It is possible to implement recording, sending and receiving of the log information using an existing technique, for example, management information base (MIB), simple network management protocol (SNMP), or the like.

The configuration of the network system 10 of FIG. 1 described above is illustrated as the main configuration for describing characteristics of the invention of the present application, and is not limited to the above-described configuration. In addition, a configuration provided in a general network system is not excluded. For example, a user terminal may be connected to the event responsive support device 1, and the event responsive support device 1 may output and display the responding method or the like on the user terminal. In addition, for example, the event responsive support device 1 is not limited to a single device, and may be implemented using a system that employs a plurality of devices

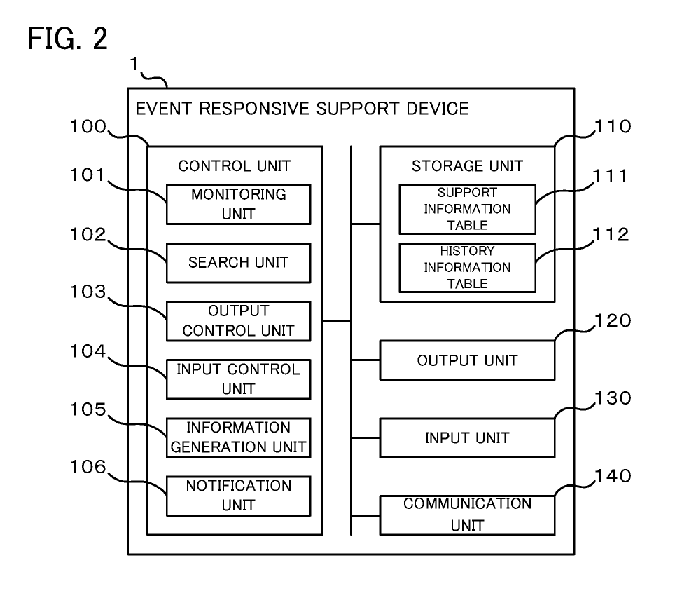

FIG. 2 is a diagram illustrating an example of a functional configuration of the event responsive support device 1. The event responsive support device 1 includes a control unit 100, a storage unit 110, an output unit 120, an input unit 130, and a communication device 140.

The output unit 120 displays a user interface (hereinafter, referred to also as “UI”) screen or the like.

The input unit 130 receives input operation of a user.

The communication device 140 performs the sending and receiving of information via the network 3.

The storage unit 110 stores information necessary for control of the event responsive support device 1 or the like. The storage unit 110 stores a support information table 111 and a history information table 112.

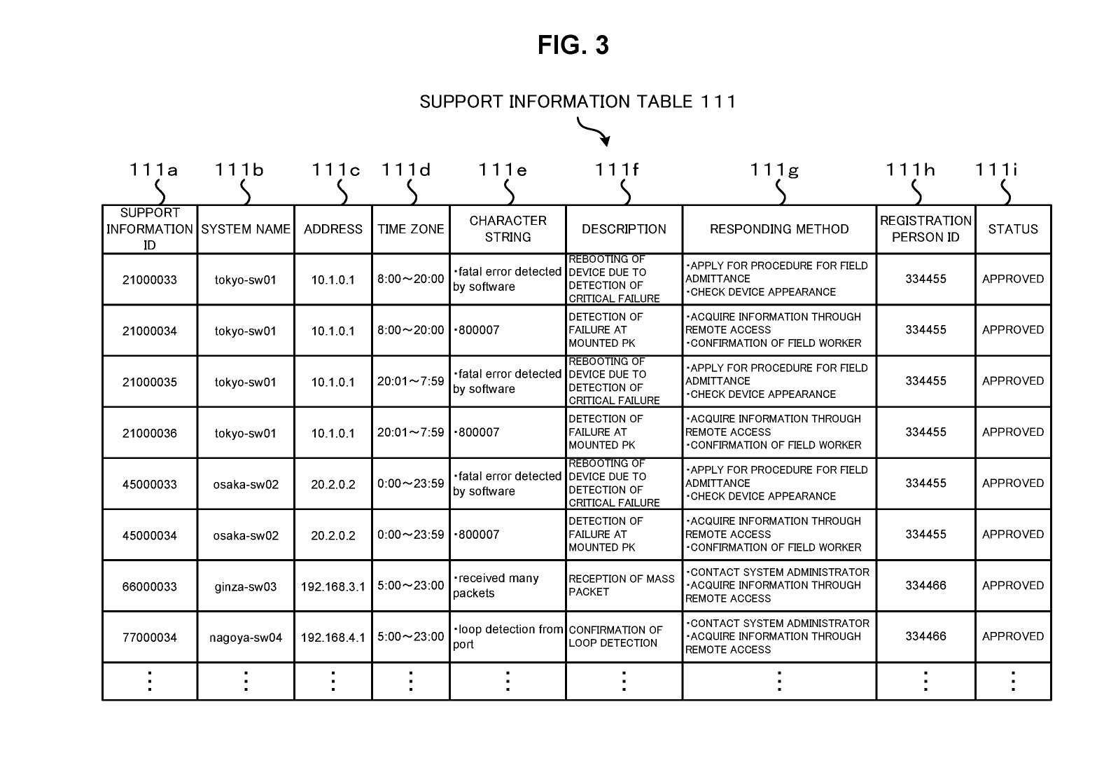

The support information table 111 stores support information, which indicates a responding method in relation to the event, specified from the log information sent from the monitoring target device 2 or the like. To be specific, for example, as illustrated in FIG. 3 (a diagram illustrating an example of a configuration of the support information table 111), the support information table 111 stores, for each of the support information, a support information record in which items of a support information ID 111a, a system name 111b, an address 111c, a time zone 111d, a character string 111e, a description 111f, a responding method 111g, a registration person ID 111h, and a status 111i are associated with each other.

The support information ID 111a is identification information of the support information.

The system name 111b is a name of a system which outputs log information associated with the support information.

The address 111c is an address of the system that outputs log information associated with the support information, and is, for example, an IP address or a MAC address.

The time zone 111d is information which indicates a time zone that includes time at which log information associated with the support information is output.

The character string 111e is a character string which is included in information associated with the support information.

The description 111f is information which describes a meaning of the character string 111e.

The responding method 111g is information that indicates a responding method in relation to an event specified from log information associated with the support information.

The registration person ID 111h is identification information of a user who has registered the support information.

The status 111i is a status of the support formation. The status includes “provisionally registered”, which indicates a state before a user performs a register operation of the support information, “waiting for approval”, which indicates a state in which approval has been requested of an approver of the support information, and “approved” which indicates a state in which the support information has been approved by the approver.

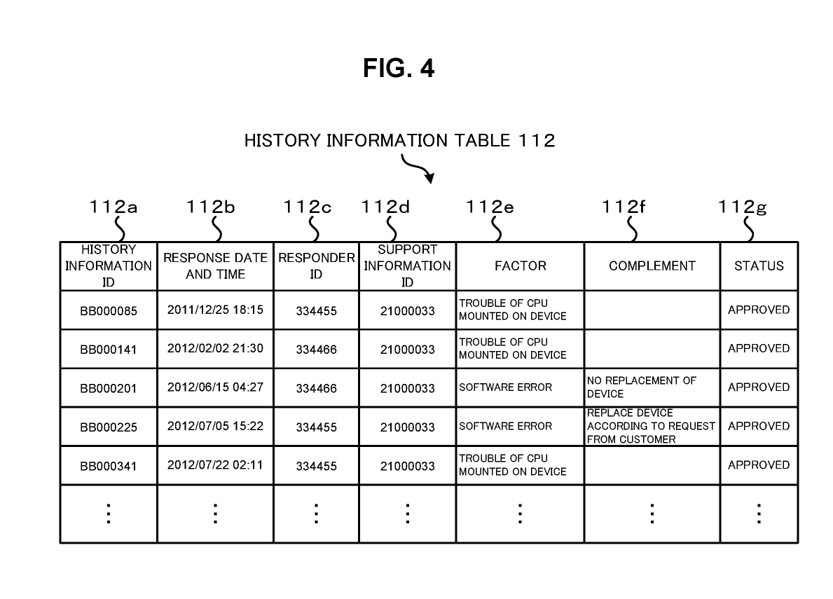

The history information table 112 stores history information which indicates use history of support information as the support information is displayed on the output unit 120, the user terminal or the like. To be specific, for example, as illustrated in FIG. 4 (a diagram illustrating an example of a configuration of the history information table 112), the history information table 112 stores, for each of the history information, a history information record in which items of a history information ID 112a, a response data and time 112b, a responder ID 112c, a support information ID 112d, a factor 112e, a complement 112f, and a status 112g are associated with each other. Each of the history information records is associated with the support information record.

The history information ID 112a is identification information of the history information.

The response data and time 112b is a date and time in which a response to an event has been performed using support information associated with the history information.

The responder ID 112c is identification information of a user that has performed a response to an event using support information associated with the history information.

The support information ID 112d is identification information of support information associated with the history information.

The factor 112e is information which indicates a factor of an event specified from log information associated with support information associated with the history information.

The complement 112f is information which indicates a complement with respect to the responding method 111g of support information associated with the history information.

The status 112g is a status of the history information. The status includes “provisionally registered”, which indicates a state before a user performs a register operation of the history information, “waiting for approval”, which indicates a state in which approval has been requested of an approver of the history information, and “approved” which indicates a state in which the history information has been approved by the approver.

A description will be given returning to FIG. 2. The control unit 100 controls the entire event responsive support device 1. The control unit 100 includes a monitoring unit 101, a search unit 102, an output control unit 103, an input control unit 104, an information generation unit 105, and a notification unit 106.

The monitoring unit 101 monitors whether log information is received from the monitoring target device 2 via the communication device 140. The monitoring unit 101 stores the received log information in, for example, the storage unit 110 or the like. Incidentally, the monitoring unit 101 may request of the monitoring target device 2 for log information using, for example, polling or the like, and receive the log information as a reply to the request In addition, for example, the monitoring target device 2 may autonomously send log information to the event responsive support device 1

The search unit 102 searches a support information record that meets a set condition from the support information table 111 and outputs the result. In addition, the search unit 102 searches a history information record that meets a set condition from the history information table 112 and outputs the result.

The output control unit 103 outputs, that is, displays the UI screen or the like, configured to support a response to an event, based on the support information record and the history information record via the output unit 120. Of course, the output control unit 103 may output and display the UI screen or the like to the user terminal (not illustrated) or the like via the communication device 140.

The input control unit 104 receives, via the input unit 130, an operation with respect to the UI screen or the like, configured to support the response to the event, output via the output unit 120. Of course, the input control unit 104 may receive an operation from the user terminal (not illustrated) or the like via the communication device 140.

The information generation unit 105 adds a support information record associated with the received log information to the support information table 111. In addition, the information generation unit 105 adds a history information record of the used support information, record to the history information table 112. In addition, the respective items included in the support information record and the history information record are updated.

The notification unit 106 sends a registration request notification, an approval request notification, an approve result notification, and the like in relation to the support information record and the history information record to a user as a notification destination via, the communication device 140.

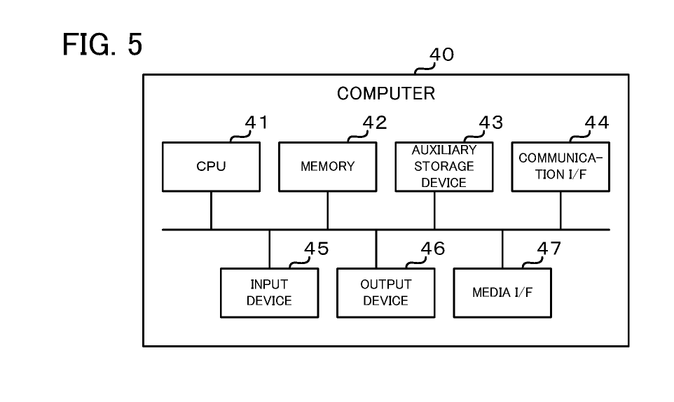

The above-described event responsive support device 1 can be implemented by a computer 40, for example, as illustrated in FIG. 5 (a diagram illustrating an example of a schematic configuration of the computer 40) which is provided with a central processing unit (CPU) 41, a memory 42, an external storage device 43 such as an HDD, a communication interface (I/F) 44 configured for connection with communication network in a wireless or wired manner, an input device 45 such as a mouse and a keyboard, an output device 46 such as a liquid crystal display, and a media I/F 47 that performs read and write of information with respect to a recording medium such as a digital versatile disk (DVD).

For example, the control unit 100 can be implemented by causing a predetermined program stored in the external storage device 43 to be loaded on the memory 42 and executed by the CPU 41. The storage unit 110 can be implemented by the CPU 41 using the memory 42 or the external storage device 43. The output unit 120 can be implemented by the CPU 41 using the output device 46. The input unit 130 can be implemented by the CPU 41 using the input device 45. The communication device 140 can be implemented by the CPU 41 using the communication I/F 44.

The above-described predetermined program may be executed by the CPU 41 by being downloaded from the network to the external storage device 43 via the communication I/F 44 and then loaded on the memory 42. In addition, the program may be executed by the CPU 41 by being directly loaded on the memory 42 from the network via the communication I/F 44. In addition, the computer 40 may load the above-described predetermined program on the external storage device 43 or the memory 42 from a storage medium set in the media I/F 47.

The functional configuration of the event responsive support device 1 of FIG. 2 described above is classified based on the main processing content in order to facilitate understanding. The invention of the present application is not limited by a way of classifying constituent elements or names thereof. The configuration of the event responsive support device 1 can be classified into a larger number of constituent elements based on processing content. In addition, it may be classified such that, one constituent element executes more processing. In addition, the processing of each constituent element may be executed by single hardware or may be executed by a plurality of hardware. In addition, the processing of each constituent element may be executed by a single program or may be executed by a plurality of programs. For example, it may be configured such that the storage unit 110 is constructed on a storage device, which is connected to the event responsive support device 1 via the network or the like, and the event responsive support device 1 acquires the support information and the history information from the storage device or updates the support information and the history information of the storage device. In addition, the above-described respective configurations of the tables of FIGS. 3 and 4 are examples, and is not limited to the illustrated examples. In addition, the support information or the history information are not limited to a table structure and may have another data structure.

Next, a description will be given regarding processing to be executed by the above-described event responsive support. device 1.

Incidentally, the event responsive support device 1 is configured to be capable of controlling login of each user (for example, an administrator of the network system 10, a responder that performs a response to an event, an approval that approves the support information, and the like), and providing service as illustrated in the following flowchart to each user in the present embodiment. In addition, the event responsive support device 1 is configured to be capable of acquiring a user ID of a user who has logged in, contact information of the user (for example, an E-mail address or the like) and the like.

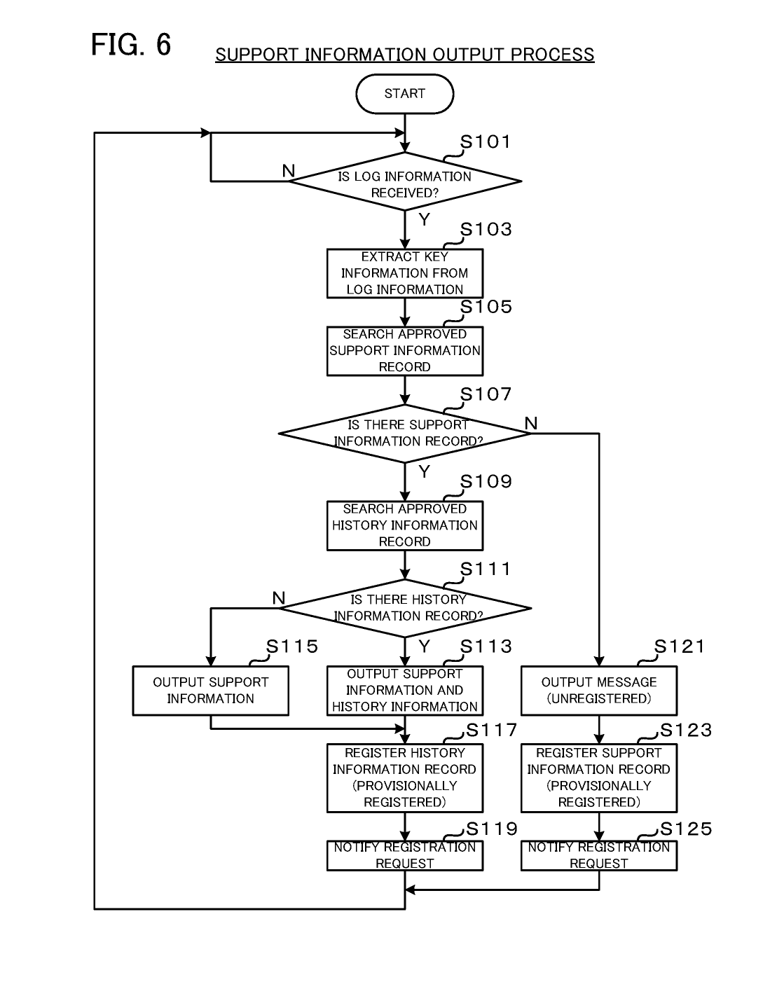

FIG. 6 is a flowchart illustrating an example of a support information output process.

The monitoring unit 101 determines whether log information is received from the monitoring target device 2 via the communication device 140 (Step S101) When the log information has not been received (Step S101: N), the determination is continued.

When the log information has been received (Step S101: Y) the search unit 102 extracts key information, which is a search key to be used to search a support information record, from the log information received in Step S101 (Step S103). To be specific, the log information is configured to include, for example, an IP address of the monitoring target device 2 as a sender of the log information, a code that indicates content of an event that has occurred, an output message that describes the content of the occurring event, an output time that indicates time of occurrence of the event, and the like. The search unit 102 extracts the sender IP address, the output time, and the output message as the key information from the received information.

Then, the search unit 102 searches an approved support information record, which matches the key information extracted in Step S103, from the support information table 111 (Step S105). To be specific, the search unit 102 searches a support information record, in which an address indicated by the address 111c matches the sender IP address of the key information, the output time of the key information is included in a time zone indicated by the time zone 111d, and a character string indicated by the character string 111e included in the output message of the key information, among support information records each of which has the status 111i of “approved”. Of course, a kind of information to be used as the key information is not limited to the above-described example. In addition, the input control unit 104 may be configured to receive setting of a user on a kind of information to be used as the key information.

Then, the search unit 102 determines whether the support information record has been specified as a result of Step S105 (Step S107)

When the support information record has been specified (Step S107: Y), the search unit 102 searches an approved history information record, which is associated with the support information record specified in Step S105, from the history information table 112 (Step S105) To be specific, the search unit 102 searches a history information record, which has the support information ID 112d that matches the support, information ID 111a of the support information record, among history information records each of which has the status 112g of “approved”.

Then, the search unit 102 determines whether the history information record has been specified as a result of Step S109 (Step S111).

When the history information record has been specified (Step S111: Y), the output control unit 103 outputs support information and history information via the output unit 120 or the communication device 140 based on the support information record specified in Step S105 and the history information record specified in Step S109 (Step S113)

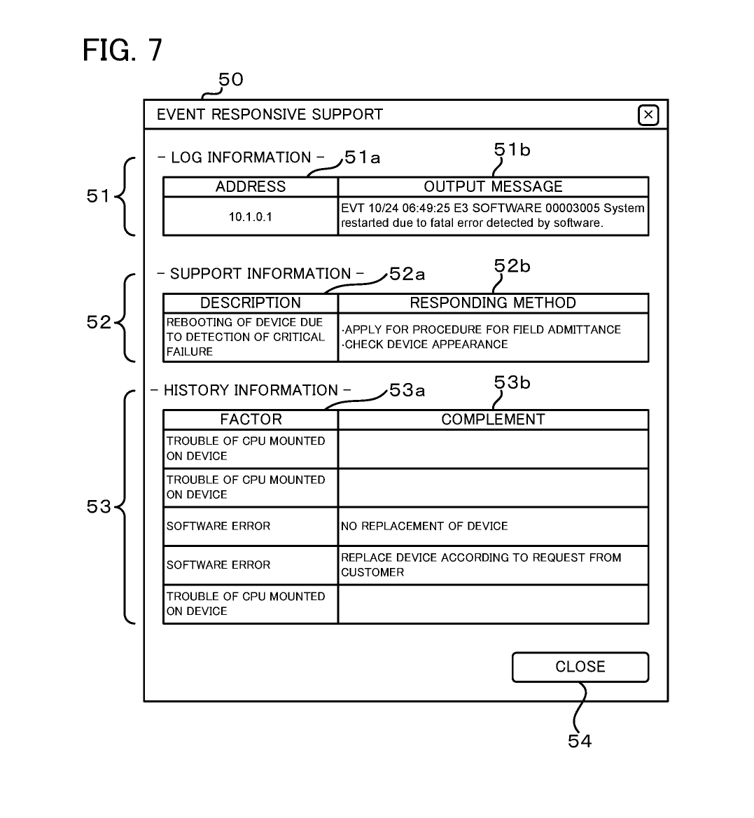

To be specific, the output control unit 103 outputs a UI. screen 50, for example, as illustrated in FIG. 7 (a diagram illustrating an example of the UI screen 50 that outputs the support information). As illustrated in this drawing, the UI screen 50 includes a log information area 51 to display content of log information, a support information area 52 to display content of support information, a history information area 53 to display content of history information, and a close button. 54 to end the display of the UI screen 50.

The output control unit 103 acquires the sender IP address and the output message from the log information received in Step S101, and outputs the sender IP address and the output message to the log information area 51 as an address 51a and an output message 51b. In addition, the output control unit 103 acquires the description 111f and the responding method 111g from the support information record specified in Step S105, and outputs the description 111f and the responding method 111g to the support information area 52 as a description 52a and a responding method 52b. In addition, the cutout control unit 103 acquires the factor 112e and the complement. 112f from the history information record specified in Step S109, and outputs the factor 112e and the complement 112f to the history information area 53 as a factor 53a and a complement 53b. When a plurality of history information records have been specified, a list of the factor 53a and the complement 53h of each record may be displayed.

Of course, the configuration of the UI screen 50 is not limited to the illustrated configuration. For example, the output control unit 103 may output any one or more items included in the log information, any one or more items included in the support information record, or any one or more items included in the history information record.

When the history information record has not been specified (Step S111: N), the output control unit 103 outputs the support information via the output unit 120 or the communication device 140 based on the support information record specified in Step S105 (Step S115). To be specific, the output control unit 103 outputs the UI screen 50, for example, as illustrated in FIG. 7 excluding the history information area 53.

Then, the information generation unit 105 registers a history information record in the history information table 112 (Step S117). To be specific, the information generation unit 105 adds a new history information record in the history information table 112. In addition, the information generation unit 105 sets a newly generated ID to the history information ID 112a and sets the support information ID 111a of the support information record specified in Step S105 to the support information ID 112d regarding the added history information record. In addition, the output time of the log information received in Step S101 is set to the response data and time 112b. In addition, the user ID of the user being logged in the event responsive support device 1 is acquired and set to the responder ID 112c. In addition, “provisionally registered” is set to the status 112g. Setting is not performed regarding the factor 112e and the complement 112f.

Then, the notification unit 106 sends notification that requests registration of the history information record that has been provisionally registered to the use being logged in the event responsive support device 1 or another user via the output unit 120 or the communication device 140 (Step S119) A method of notification may be configured, for example, such that an E-mail is sent to an E-mail address of the user or a pop-up screen is displayed on the output device 46 or a terminal of the user. After end of Step S119, the control unit 100 returns the processing to Step S101.

On the other hand, the support information record has not been specified (Step S107: N), the output control unit 103 outputs a message indicating a fact that the support information is unregistered via the output unit 120 or the communication device 140 (Step S121).

Then, the information generation unit 105 registers a support information record in the support information table 111 (Step S123). To be specific, the information generation unit 105 adds a new support information record in the support information table 111. In addition, the information generation unit 105 sets a newly generated ID to the support information ID 111a regarding the added support information record. In addition, the sender IP address, the output time, and the output message of the log information received in Step S101 are set to the address 111c, the time zone 111d, and the character string 111e. In addition, the user ID of the user being logged in the event responsive support device 1 is acquired and set to the registration person ID 111h. In addition, “provisionally registered” is set to the status 111i. Setting is not performed regarding the system name 111b, the description 111f, and the responding method 111g.

Then, the notification unit 106 sends notification that requests registration of the support information record that has been provisionally registered to the user being logged in the event responsive support device 1 or another user via the output unit 120 or the communication device 140 (Step S125). A method of notification may be configured, for example, such that an E-mail is sent to an E-mail address of the user or a pop-up screen is displayed on the output device 46 or a terminal of the user. After end of Step S125, the control unit 100 returns the processing to Step S101.

In the above-described manner, the support information associated with the log information and the history information relating to the support information are output. The user can determine the responding method to the event specified from the log information by confirming not only the output support information but also the history information relating to the support information.

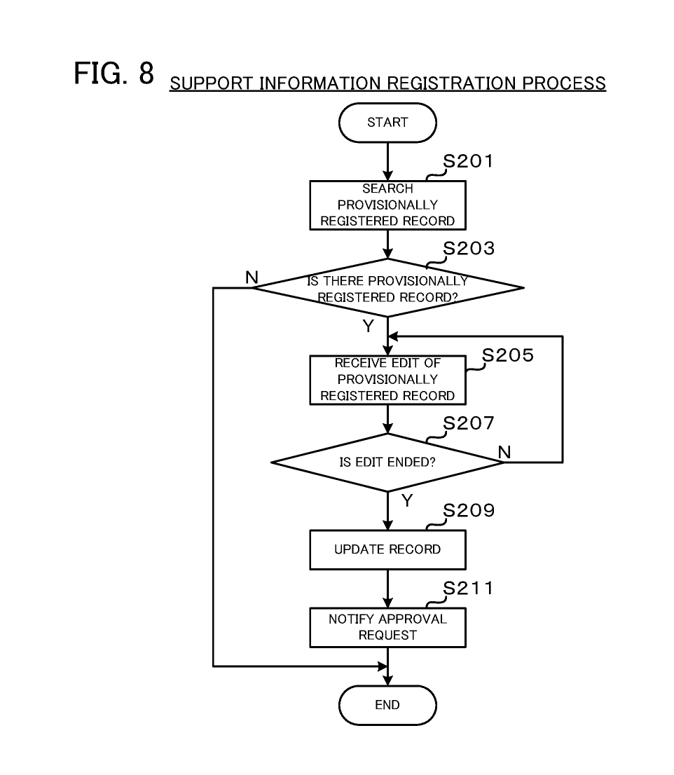

FIG. 8 is a flowchart illustrating an example of a support information registration process.

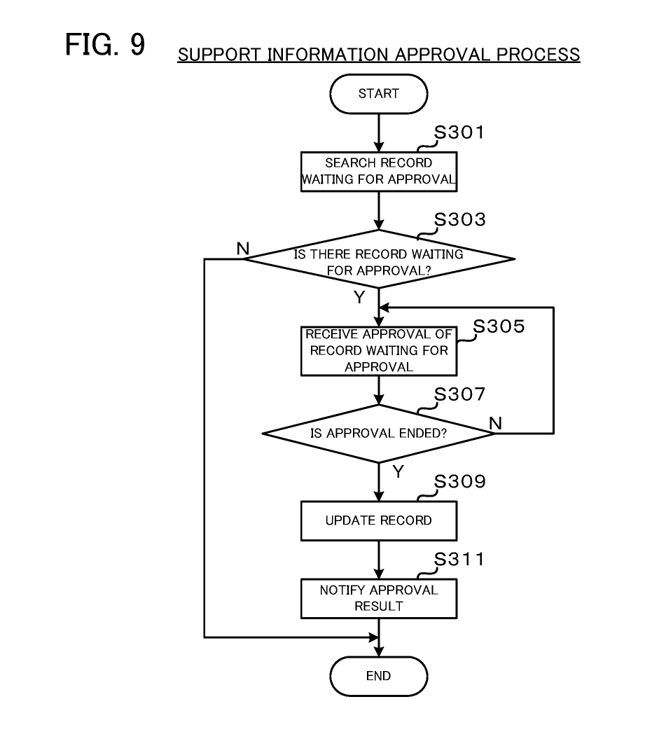

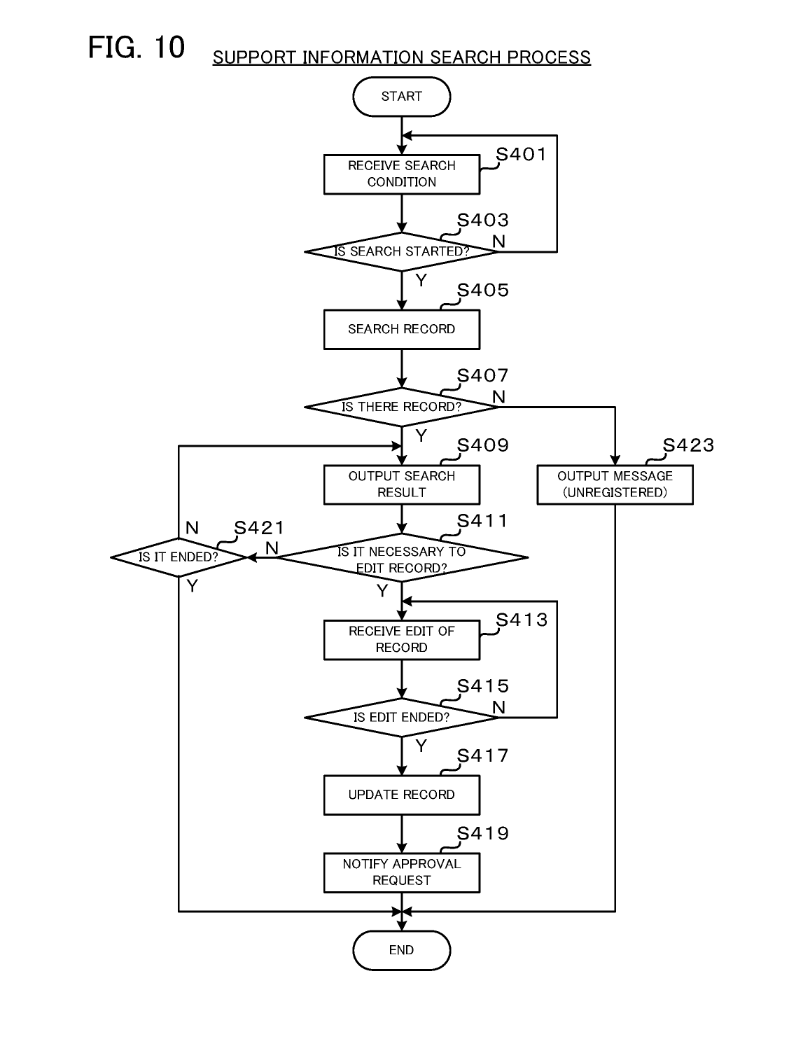

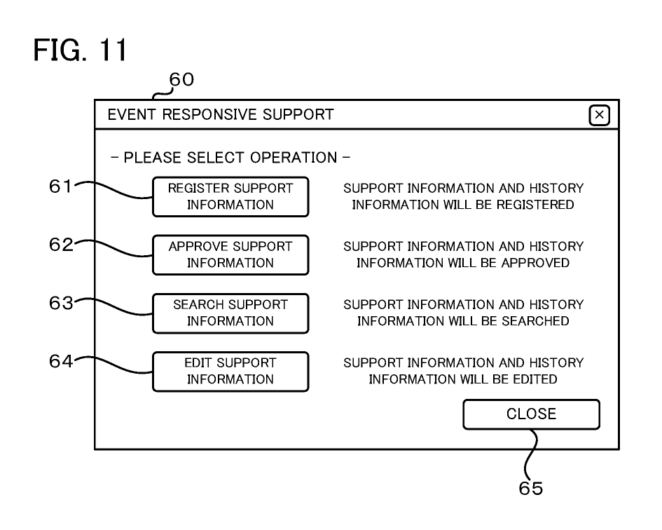

This flowchart is started, for example, when the event responsive support device 1 receives an instruction to start the support information registration process from a user or the like that receives the above-described registration request notification. To be specific, the output control unit 103 output a UI screen 60, for example, as illustrated in FIG. 11 (a diagram illustrating an example of the UI screen 60 to which an operation with respect to the support information is input) via the output unit 120 or the communication device 140 after the user is logged in. As illustrated in this drawing, the UI screen 60 includes a support information registration button 61 to start the support information registration process (see FIG. 8), a support information approval button 62 to start a support information approval process (see FIG. 9), a support information search button 63 to start a support information search process (see FIG. 10), a support information edit button 64 to start a support information edit process (see FIG. 10 similarly to the support information search process), and a close button 65 to end the display of the UI screen 60.

The input control unit 104 receives an input operation on the UI screen 60 via the input unit 130 or the communication device 140. The control unit 100 starts this flowchart when the support information registration button 61 is clicked or the like.

The search unit 102 searches a support information record having the status 111i of “provisionally registered” from the support information table 111 (Step S201). In addition, the search unit 102 searches a history information record having the status 112g of “provisionally registered” from the history information table 112 (Step S201).

Then, the search unit 102 determines whether the provisionally registered record has been specified as a result of Step S201 (Step S203). When the provisionally registered record has not been specified (S203: N), the control unit 100 ends the processing of this flowchart.

When the provisionally registered record has been specified (Step S203: Y), the control unit 100 receives edit of the provisionally registered record (Step S205). To be specific, the output control unit 103 acquires the provisionally registered support information record specified in Step S201 and the history information record associated with the support information record from the support information table 111 and the history information table 112 and displays a list of each item of the acquired records on the UI screen. In addition, the input control unit 104 receives an edit operation of each item of each record on the UI screen. Erase of the record may be also received. In addition, the input control unit 104 receives an operation that ends the edit on the UI screen.

The user can set an item that has not been set, for example, in Step S123 (see FIG. 6), the system name 111b, the description 111f, and the responding method 111a regarding the support information record on the UI screen as described above. Of course, an item that has been set in Step S123 (see FIG. 6) can be edited. In addition, the user can set an item that has not been set, for example, in Step S117 (see FIG. 6), the factor 112e, and the complement 112f regarding the history information record. Of course, an item that has been set in Step S117 (see FIG. 6) can be edited.

Here, the user can change content of each item such that each item of the support information record appropriately functions as the search key. For example, an output time set in the time zone 111d can be changed to a time zone that includes the output time. In addition, for example, an output message set in the character string 111e can be changed to a partial character string included in the output message. The other items can be changed in the same manner.

In addition, the user can respond to an event based on the support information record output in Step S115 or Step S113 (see FIG. 6), then, analyze a factor of the event, and set the factor as the factor 112e of a history information record associated with the support information record. In addition, the user can respond to an event based on the support information record output in Step S115 or Step S113 (see FIG. 6), then, analyze an error or insufficiency the support information, and set the complement 112f of a history information record associated with the support information record.

The control unit 100 determines whether an operation that ends the edit of the provisionally registered record has been performed (Step S207). When there is no operation that ends the edit (Step S207: N), the processing returns to S205, and the receiving of the edit is continued.

When the operation that ends the edit has been performed (Step S207: Y), the information generation unit 105 updates each corresponding record in the support information table 111 or the history information table 112 with content of each item of each provisionally registered record that has been edited in Step S205 (Step S209). In addition, “waiting for approval” is set to the status lilt or the status 112g of the updated record (Step S209).

Then, the notification unit 106 sends notification that requests approval of the support information record and the history information record whose approvals are waiting for to a user designated as an approver in advance or another user via the output unit 120 or the communication device 140 (Step S211). A method of notification may be configured, for example, such that an E-mail is sent to an E-mail address of the user or a pop-up screen is displayed on the output device 46 or a terminal of the user. After end of Step S211, the control unit 100 ends the processing of this flowchart.

In the above-described manner, it is possible to add information to insufficient information or correct unsuitable content with respect to the provisionally registered support information and the provisionally registered history information. Thus, it is possible to improve each quality of the support information and the history information such that a response to an event can be more rapidly and accurately performed.

FIG. 9 is a flowchart illustrating an example of the support information approval process.

This flowchart is started, for example, when the event responsive support device 1 receives an instruction to start the support information approval process from a user such as an approver or the like that receives the above-described approval request notification. To be specific, the output control unit 103 outputs the UI screen 60, for example, as illustrated in FIG. 11. The control unit 100 starts this flowchart when the support information approval button 62 is clicked or the like.

The search unit 102 searches a support information record having the status 111i of “waiting for approval” from the support information table 111 (Step S301). In addition, the search unit 102 searches a history information record having the status 112g of “waiting for approval” from the history information table 112 (Step S301).

Then, the search unit 102 determines whether the record waiting for approval has been specified as a result of Step S301 (Step S303). When the record waiting for approval has not been specified (S303: N), the control unit 100 ends the processing of this flowchart.

When the record waiting for approval has been specified (Step S303: Y), the control unit 100 receives approval of the record waiting for approval (Step S305). To be specific, the output control unit 103 acquires the support information record. waiting for approval specified in Step S301 and the history information record associated with the support information record from the support information table 111 and the history information table 112 and displays a list of content of each item of the acquired records on the UI screen. In addition, the input control unit 104 receives an approval operation of each record on the UI screen. In addition, the input control unit 104 receives an operation that ends the approval on the UT screen. Incidentally, the input control unit 104 may also receive an edit operation of content of each item of each record on the UI screen.

The approver can review the content regarding each record updated in, for example, Step S209 (see FIG. 8) and set either “approved” or “impossible to approve” on the UI screen as described above. In addition, it is possible to edit each record.

The control unit 100 determines whether an operation that ends the approval of the record waiting for approval has been performed (Step S307). When there is no operation that ends the approval (Step S307: N), the processing returns to S305, and the receiving of the approval is continued.

When the operation that ends the approved has been performed (Step S307: Y), the information generation unit 105 updates each corresponding record in the support information table 111 or the history information table 112 with content of each item of each record waiting for approval that has been edited in Step 3305 (Step S309). In addition, “approved” is set to the status 111i or the status 112g of the record to which the approval has been set in Step S305 (Step S309). In addition, “provisionally registered” is set to the status 111i or the status 112e of the record to which “impossible to approve” has been set in Step S305 (Step S309).

Then, the notification unit 106 sends notification of an approval result (approved or impossible to approve) regarding each support information record waiting for approval to the user indicated by the registration person ID 111h or another user via the output unit 120 or the communication device 140 (Step S311) The notification unit 106 sends notification of an approval result (approved or impossible to approve) regarding each history information record waiting for approval to the user indicated by the responder ID 112c or another user via the output unit 120 or the communication device 140 (Step S311). A method of notification may be configured, for example, such that an E-mail is sent to an E-mail address of the user or a pop-up screen is displayed on the output device 46 or a terminal of the user. After end of Step S311, the control unit 100 ends the processing of this flowchart.

In the above-described manner, the approver can add information to insufficient, information or correct unsuitable content with respect to the support information waiting for approval and the history information waiting for approval. It is possible to make a registration person or the like re-examine the support information and the history information by notifying of the status of being impossible to approve. Thus, it is possible to improve each quality of the support information and the history information such that a response to an event, can be more rapidly and accurately performed. For example, it is easy to improve the quality of the support information and the history information if the approver is set to a person who has higher capability and experience than the registration person or the like.

FIG. 10 is a flowchart illustrating an example of a support information search process and a support information edit process.

This flowchart is started, for example, when the event responsive support device 1 receives an instruction to start the support information search process or the support information edit process from a user. To be specific, the output control unit 103 outputs the UI screen 60, for example, as illustrated in FIG. 11. The control unit 100 starts this flowchart when the support information search button 63 or the support information edit button 64 is clicked or the like.

The control unit 100 receives a search condition (Step S401) To be specific, the output control unit 103 outputs a UI screen which is configured to receive each search condition of the support information record and the history information record. For example, a value, a range of the value, a keyword, and the like, in relation to at least one or more items among the support information ID, the system name, the address, the time zone, the character string, the description, the responding method, the registration person ID, and the status are received as the search condition with respect to the support information record. For example, a value, a range of the value, a keyword, and the like, in relation to at least one or more items among the history information ID, the response data and time, the responder ID, the support information ID, the factor, the complement, and the status are received as the search condition with respect to the history information record. In addition, the input control unit 104 receives a setting operation of the search condition on the UI screen. In addition, the input control unit 104 receives an operation that starts search on the UI screen.

The control unit 100 determines whether an operation that starts the search has been performed (Step S403). When there is no operation that starts the search (Step S403: N), the processing returns to S401, and the receiving of the search condition is continued.

When there is the operation that starts the search (Step S403: Y), the search unit 102 acquires the search condition set in Step S401, searches a support information record that meets the search condition with respect to the support information record from the support information table 111, and searches a history information record that meets the search condition with respect to the history information record from the history information table 112 (Step S405).

Then, the search unit 102 determines whether the record that meets the search condition has been specified as a result of Step S405 (Step S407).

When the record that meets the search condition has been specified (Step S407: Y), the control unit 100 outputs a search result (Step S409). To be specific, the output control unit 103 acquires the records specified in Step S407 from the support information table 111 and the history information table 112, and displays a list of content of the acquired records on the UI screen. In addition, the input control unit 104 receives an operation that starts edit of the record on the UI screen. In addition, the input control unit 104 receives an operation that ends the output of the search result on the UI screen.

The control unit 100 determines whether the operation that starts the edit of the record has been performed (Step S411).

When the operation that starts the edit of the record has been performed (Step S411: Y) the control unit 100 receives the edit of the record which has been output in Step S409 (Step S413). To be specific, the input control unit 104 receives an edit operation of content of each record on the UI screen which has been output in Step S409. In addition, the input control unit 104 receives an operation that ends the edit on the UI screen.

For example, the user can review and correct the content of the support information record and the history information record on the UI screen as described above.

The control unit 100 determines whether an operation that ends the edit of the record has been performed (Step S415) When there is no operation that ends the edit (Step S415: N), the processing returns to S413, and the receiving of the edit is continued.

When the operation that ends the edit has been performed (Step S415: Y), the information generation unit 105 updates each corresponding record in the support information table 111 or the history information table 112 with content of each item of each record that has been edited in Step S413 (Step S417). In addition, “waiting for approval” is set to the status 11i or the status 112g of the updated record (Step S417).

Then, the notification unit 106 sends notification that requests approval of the support information record and the history information record whose approvals are waiting for to a user designated as an approver in advance or another user via the output unit 120 or the communication device 140 (Step S419). A method of notification may be configured, for example, such that an E-mail is sent to an E-mail address of the user or a pop-up screen is displayed on the output device 46 or a terminal of the user. After end of Step S419, the control unit 100 ends the processing of this flowchart.

On the other hand, when there is no operation that starts the edit of the record (Step S411: N), the control unit 100 determines whether the operation that ends the output of the search result has been performed (Step S421). When there is no operation that ends the output of the search result (Step S421: N), the processing returns to Step S409, and the output of the search result is continued. When there is no operation that ends the output of the search result (Step S421: N), the control unit 100 ends the processing of this flowchart.

Meanwhile, the record that meets the search condition has not been specified (Step 407: N), the output control unit 103 outputs a message indicating a fact that the record that meets the search condition is unregistered via the output unit 120 or the communication device 140 (Step S423). After end of Step S423, the control unit 100 ends the processing of this flowchart

In the above-described manner, it is possible to search arbitrary support information and history information, and to add information to insufficient information or correct unsuitable content with respect to the searched support information and history information if necessary. Thus, it is possible to improve each quality of the support information and the history information such that a response to an event can be more rapidly and accurately performed. For example, it is easy to improve the quality of the support information and the history information if a person who performs the review of the support information and the history information is set to a person who has higher capability and experience than the approver or the like.

Units of processing of the flowcharts in FIGS. 6 and 8 to 10 described above are divided based on the main processing content in order to facilitate understanding of the processing in the event responsive support device 1. The invention of the present application is not limited by a way of dividing the units of processing or names thereof. The processing of the event responsive support device 1 can be divided into a larger number of units of processing based on processing content. In addition, it may be divided such that one unit of processing include more processing. In addition, the above-described processing order of the flowchart is not limited to the example illustrated in the drawings. In addition, the configuration of the UI screen illustrated in FIGS. 7 and 11, and the like is not limited to the examples illustrated in the drawings.

The first embodiment of the present invention has been described as above. According to the present embodiment, it is possible to support the user to be capable of more rapidly and accurately executing the response to the event occurring in the device.

### First Modification Example

A first modification example of the first embodiment will be described with reference to the drawings. In the present modification example, the event responsive support device 1 associates support information with reliability and out buts both the support information and the reliability. The reliability serves as a criterion on any level of the support information that can be believed at the time of responding to an event such as device trouble or the like, for example. Hereinafter, the same configuration as in the first embodiment will be denoted by the same reference numeral and will not be described, and a description will be given focusing on a different point from the first embodiment.

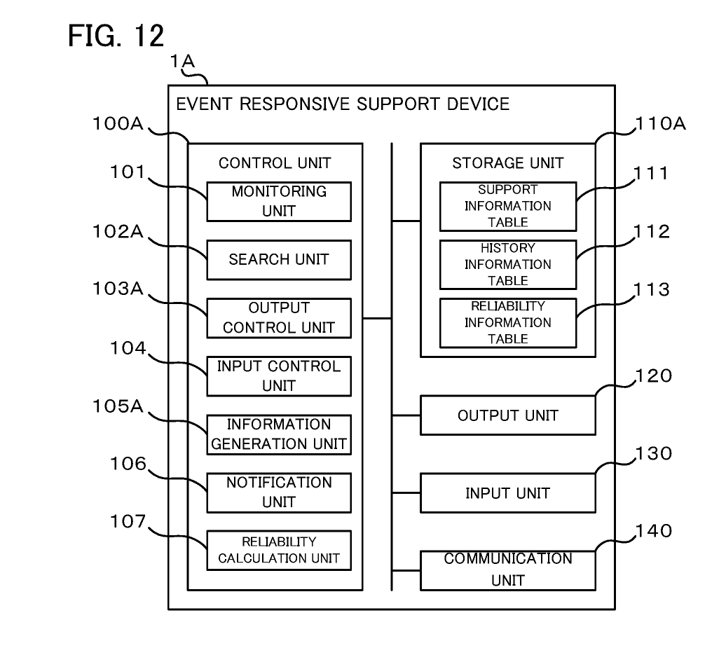

FIG. 12 is a diagram illustrating an example of a functional configuration of an event responsive support device 1A according to the first modification example.

A reliability information table 113 is stored in a storage unit 110A.

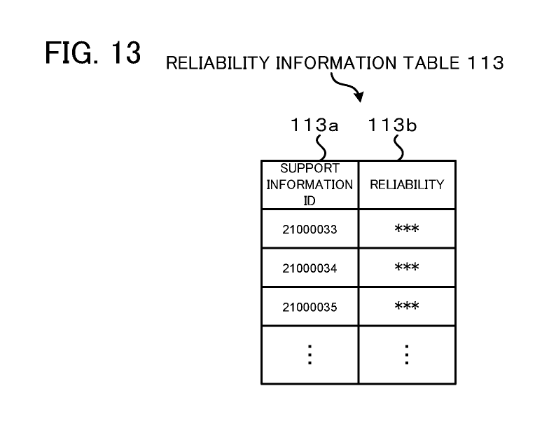

The reliability information table 113 stores reliability information of a support information record, which is stored in the support information table 111. To be specific, for example, as illustrated in FIG. 13 (a diagram illustrating an example of a configuration of the reliability information table 113), the reliability information table 113 stores, for each of the support information, a reliability information record in which a support information ID 113a and a reliability 113b are associated with each other. The support information ID 113a is identification information of support information associated with the reliability information. The reliability 113b is reliability of support information associated with the reliability information.

A description will be given returning to FIG. 12. A control unit 100A includes a reliability calculation unit 107.

The reliability calculation unit 107 calculates and updates the reliability 113b of the reliability information record stored in the reliability information table 113 at a predetermined timing according to a predetermined method. The reliability calculation unit 107 will be described later in detail.

A search unit 102A searches and specifies a support information record that meets a set condition from the support information table 111, and se-arches and specifies a reliability information record associated with the specified support information record from the reliability information table 113.

An output control unit 103A outputs support information and the reliability thereof based on the support information record and the reliability information record associated with the support information specified by the search unit 102A at the time of outputting content of the support information record, for example, in Step S113 and Step S115 (see FIG. 6).

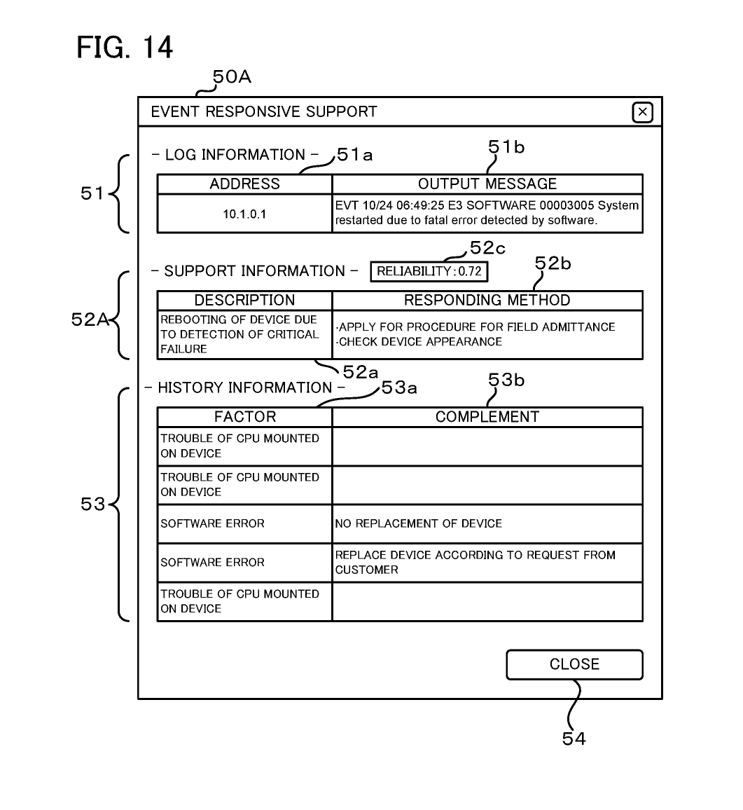

To be specific, the output control unit 103A outputs a UI screen 50A, for example, as illustrated in FIG. 14 (a diagram illustrating an example of the UI screen 50A that outputs the reliability). The output control unit 103A acquires the reliability 113b specified by the search unit 102A and outputs the reliability 113b to a support information area 52A as a reliability 52c.

A description will be given returning to FIG. 12. An information generation unit 105A registers a reliability information record associated with a registered support information record in the reliability information table 113 at the time of registering the support information record in the support information table 111, for example, in Step S123 (see FIG. 6). To be specific, the information generation unit 105A adds a new reliability information record to the reliability information table 113. In addition, the support information ID 111a of the registered support information record is set to the support information ID 113a. Setting is not performed on the reliability 113b.

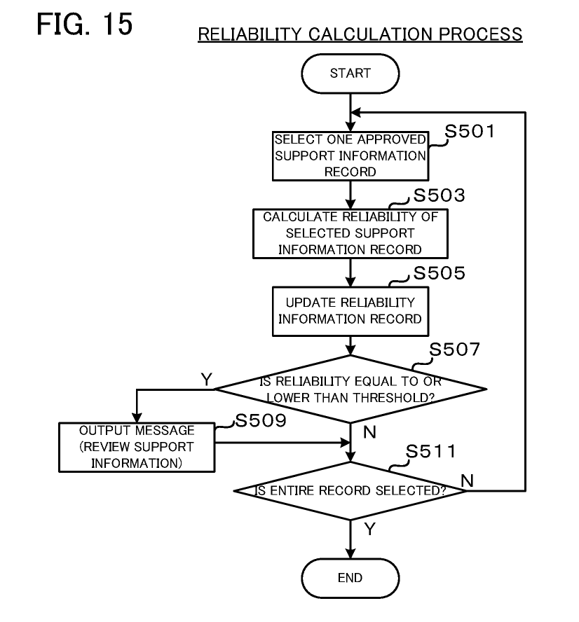

FIG. 15 is a flowchart illustrating an example of a reliability calculating process. This flowchart is started at, for example, a regular timing.

The search unit 102A selects one of unselected records among support information records each of which has the status 111i of “approved” with reference to the support information table 111 (Step S501). Incidentally, when there is no approved support information record, and the control unit 100 may end the processing of this flowchart.

Then, the reliability calculation unit 107 calculates reliability of the support information record selected in Step S501 (Step S503).

To be specific, the reliability calculation unit 107 acquires the history information record having the status 112g of “approved” which is associated with the support information record selected in Step S501 from the history information table 112. Further, for example, the reliability is calculated using the following method (1) or (2). Incidentally, a range in which reliability can be taken is set to, for example, 0 (reliability is low) to 1 (reliability is high) in the present modification example.

(1) A proportion of the number of history information records of the complements 112f to which nothing is set with respect to the total number of acquired history information records is set as the reliability. The reliability increases as the proportion is high.

(2) A proportion of the number of history information records with the complements 112f to which nothing is set with respect to the total number of acquired history information records is set as the reliability. However, records having the same factor 112e is counted as one record. The reliability increases as the proportion is high.

Of course, the above-described calculation methods or reliability are examples, and another method may be used as long as reliability, which is as objective as possible, can be calculated.

For example, it may be configured such that an average number of history information records, associated with a support information record, per unit period is calculated as a use frequency of the support information record, and reliability is set to a value such that the reliability decreases as the use frequency decreases. In addition, it may be configured such that, for example time that has elapsed from a date and time in which the support information record has been approved is measured, and reliability is set to a value such that the reliability decreases as the elapsed time increases. In addition, it may be configured such that, for example, a total number of history information records associated with a support information record is acquired, and reliability is set to a value such that the reliability increases as the total number increases.

In addition, it may be configured such that, for example, a character string of the responding method 111g of a support information record and a character string of an official responding method in relation to log information associated with the support information record (for example, a responding method in relation to log information may be acquired from a manual published on the WEB based on a model name or the like of a system that outputs the log information) are compared to calculate a difference, and reliability is set to a value such that the reliability increases as the difference decreases.

In addition, it may be configured such that, for example, the number of time at which a status of a support information record is changed from “waiting for approval” to “approved” is counted as a review count, and reliability is set to a value such that the reliability increases as the review count increases. In addition, it may be configured such that, for example, a level, of an approver that has approved a support information record is specified using a user level information table 115, which will be described later, and reliability is set to a value such that the reliability increases as the level of the approver increases.

In addition, it may be configured such that, for example, any two or more types of reliability among the above-described types of reliability are combined, and a sum or a product of each reliability is calculated as the reliability. Each reliability may be multiplied by a weighting coefficient set for each reliability when the sum or product of each reliability is calculated.

Incidentally, it may be configured such that the reliability can be changed as the input control unit 104 receives setting of the user such as the registration person, the approver, the responder or the like via the input unit 130 or the communication device 140.

Then, the information generation unit 105A updates the reliability information record by setting the reliability calculated in Step S503 to the reliability 113b associated with the support information record selected in Step S501 (Step S505).

Then, the output control unit 103A determines whether the reliability calculated in Step S503 is equal to or lower than a predetermined threshold (Step S507). Incidentally, the input control unit 104 may receive a change of setting of the predetermined threshold via the input unit 130 or the communication device 140.

When the reliability is equal to or lower than the predetermined threshold (Step S507: Y), the output control unit 103A outputs a message to encourage the review of content of the support information record selected in Step S501 via the output unit 120 or the communication device 140 (Step S509). The user who has confirmed the message can review and correct the content of the support information through, for example, the support information search process and the support information edit process (see FIG. 10).

When the reliability exceeds the predetermined threshold (Step S507: N), or after end of Step S509, the search unit 102A determines whether the entire support information record having the status 111i of “approved” has been selected (Step S511). When none of the records has been selected (Step S511: N), the search unit 102A returns the processing to Step S501. When the entire record has been selected (Step S511: Y), the control unit 100A ends the processing of this flowchart.

The first modification example has been described as above. According to the present modification example, the reliability of support information is calculated and displayed together with the support information, and thus, the user can respond to the event upon consideration of the reliability of the support information. If the reliability is low, the user can determine, for example, whether various factors need to be assumed or the like. In addition, the user can determine whether the support information needs to be reviewed based on the reliability or the message, and thus it is possible to maintain or improve the quality of the support information as much as possible.

### Second Modification Example

A second modification example of the first embodiment will be described with reference to the drawings. In the second modification example, the event responsive support device 1 associates support information with a difficulty of a response to an event, which is associated with the support information, and outputs the difficulty together with the support information. The difficulty serves as a criterion, for example, to determine whether a responder needs to seek another person's assistance or the like at the time of responding to the event such as device trouble. In addition, the event responsive support device 1 outputs advice or the like at the time of responding to the event based on a user's level in the present modification example. Hereinafter, the same configuration as in the first embodiment will be denoted by the same reference numeral and will not be described, and a description will be given focusing on a different point from the first embodiment.

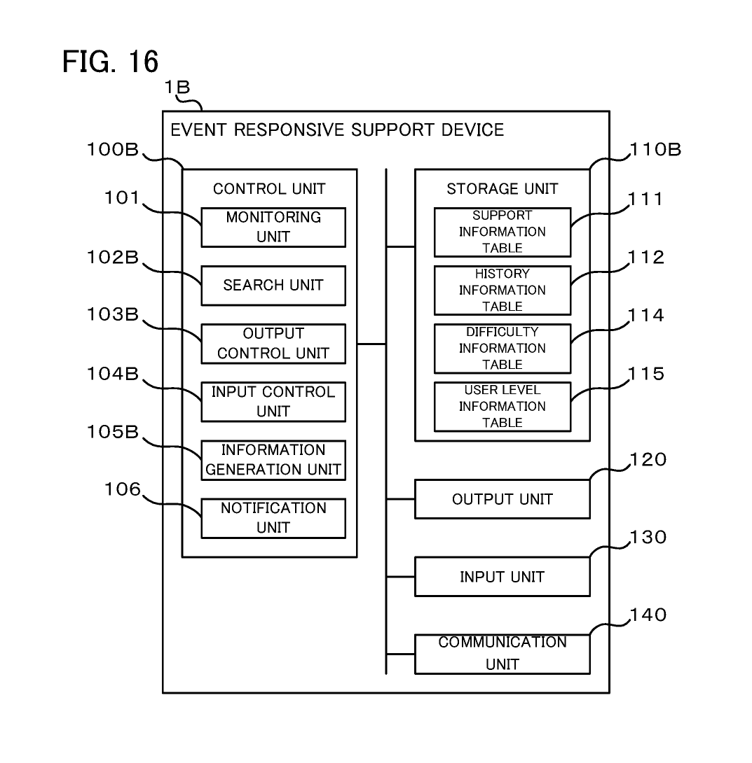

FIG. 16 is a diagram illustrating an example of a function configuration of an event responsive support device 1B according to the second modification example.

A difficulty information table 114 and a user level information table 115 are stored in a storage unit 110B.

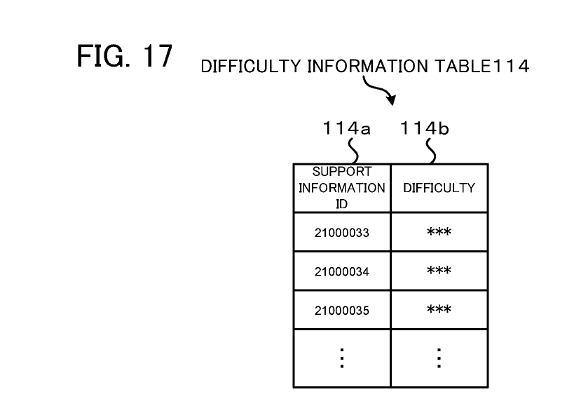

The difficulty information table 114 stores difficulty information of a support information record, which is stored in the support information table 111. To be specific, for example, as illustrated in FIG. 17 (a diagram illustrating an example of a configuration of the difficulty information table 114), the difficulty information table 114 stores, for, each of the support information, a difficulty information record in which a support information ID 114a and a difficulty 114b are associated with each other. The support information ID 114a is identification information of support information associated with the difficulty information. The difficulty 114b is a difficulty of a response to an event in relation to the support information associated with the difficulty information.

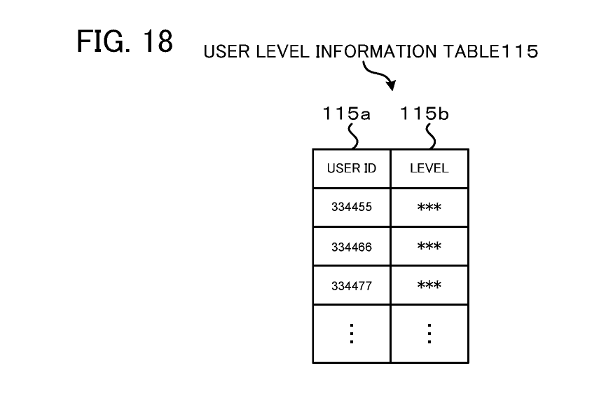

The user level information table 115 stores an ability level of a user to respond to an event be specific, for example, as illustrated in FIG. 18 (a diagram illustrating an example of a configuration of the user level information table 115), the user level information table 115 stores, for each of the user, a user level information record in which a user ID 115a and a level 115b are associated with each other. The level 115b is information which indicates an ability level of the user to respond to an event.

A description will be given returning to FIG. 16. A search unit 102B searches and specifies a support information record that meets a set condition from the support information table 111, and searches and specifies a difficulty information record associated with the specified support information record from the difficulty information table 114. In addition, the search unit 102B searches and specifies a user level information record that meets a set condition from the user level information table 115.

An output control unit 103B outputs support information and the difficulty thereof based on the support information record and the difficulty information record associated with the support information specified by the search unit 1028 at the time of outputting content of the support information record, for example, in Step S113 and Step S115 (see FIG. 6). In addition, the output control unit 103B outputs advice or the like at the time of responding to the event based on the difficulty specified by the search unit 102B and the level of the user being logged in the event responsive support device 1.

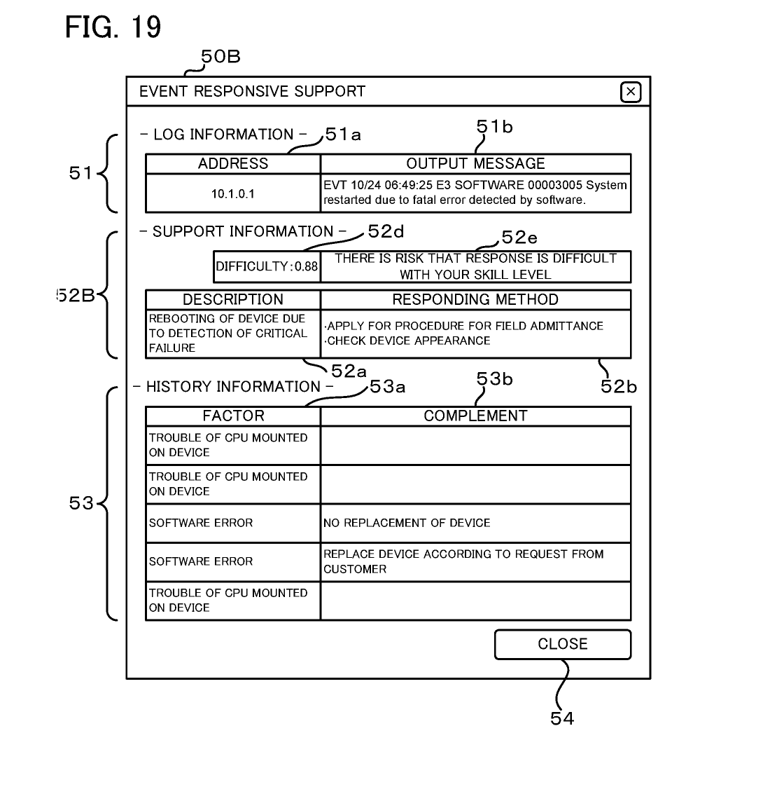

To be specific, the output control unit 1038 outputs a UI screen 50B, for example, as illustrated in FIG. 19 (a diagram illustrating an example of the UI screen 50B that outputs the difficulty). The output control unit 103B acquires the difficulty 114b specified by the search unit 102B and outputs the difficulty 114b to a support information area 52B as a difficulty 52d. In addition, the output control unit 103B determines advice content according to the following method, for example, and outputs the advice content to the support information area 52B as advice 52e. Of course, the output control unit 103B may be configured to output any one of the difficulty and the advice.

A determination table in which a user level. (for example, a natural number among 1 to 6) that can respond to an event of a difficulty is allocated to each of difficulties (for example, a natural number among 1 to 3) is prepared in advance (for example, a difficulty 1: user levels 1 to 2, a difficulty 2: user levels 3 to 4, and a difficulty 3: user levels 5 to 6). The output control unit 103B acquires the level 115b of a user from the user level information table 115 based on the user ID of the user being logged in the event responsive support device 1. Further, a user level associated with the acquired difficulty 114b is referenced using the determination table, and it is determined whether the acquired level 115b is lower than the referenced user level.

When the acquired level 115b is lower than the referenced user level, the output control unit 103B determines a character string, for example, “there is a risk that a response is difficult with your skill level” or the like as the advice content. When the acquired level 115b is equal to or higher than the referenced user level, the output control unit 103B does not necessarily determine the advice content or may determine an arbitrary character string as the advice content

A description will be given returning to FIG. 16. The output control unit 103B outputs support information and the difficulty thereof based on the support information record and the difficulty information record associated with the support information in, for example, Step S205 (see FIG. 8), Step S305 (see FIG. 9), and Step S413 (see FIG. 10) at the time or receiving edit of content of the support information record. An input control unit 104B receives edit of the difficulty.

An information generation unit 1053 registers a difficulty information record associated with a registered support information record in the difficulty information table 114 at the time of registering the support information record in the support information table 111, for example, in Step S123 (see FIG. 6). To be specific, the information generation unit 1053 adds a new difficulty information record to the difficulty information table 114. In addition, the support information ID 111a of the registered support information record is set to the support information ID 114a. Setting is not performed on the difficulty 114b. In addition, when the difficulty is edited, the information generation unit 105B updates a difficulty information record by setting the edited difficulty to the difficulty 114b of the difficulty information record.

The second modification example has been described as above. According to the present modification example, the difficulty of support information is displayed together with the support information, and thus, the user can respond to the event upon consideration of the difficulty of the support information. If the difficulty is high, the user can determine, for example, whether it is necessary to ask another user' s assistance or the like. In addition, the user easily perform determination since the advice is displayed.

### Third Modification Example

A third modification example of the first embodiment will be described with reference to the drawings. In the third modification example, the event responsive support device 1 associates support information with urgency of a response to an event, which is associated with the support information, and outputs the urgency together with the support information. The urgency serves as a criterion, for example, to determine how much a responder needs to hurry a response at the time or responding to an event such as device trouble. Hereinafter, the same configuration as in the first embodiment will be denoted by the same reference numeral and will not be described, and a description will be given focusing on a different point from the first embodiment.

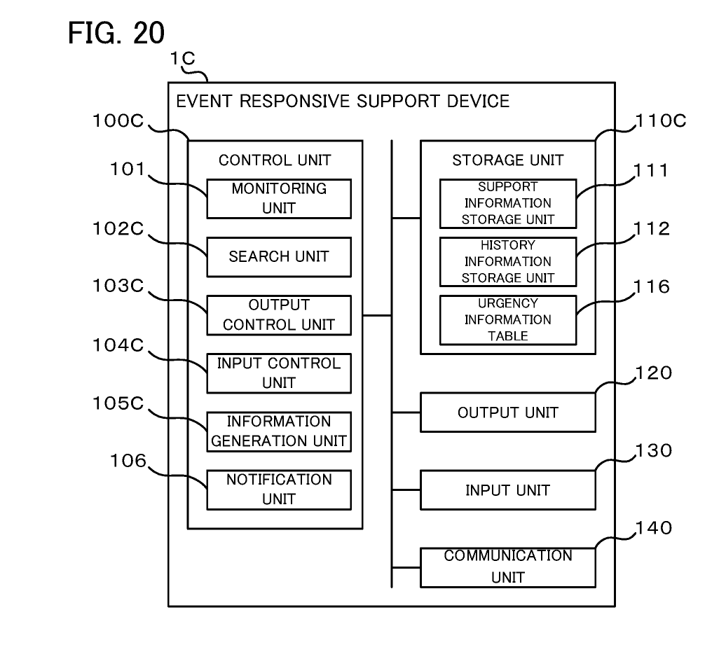

FIG. 20 is a diagram illustrating an example of a functional configuration of an event responsive support device 1C according to the third modification example.

An urgency information table 116 is stored in a storage unit 1100.

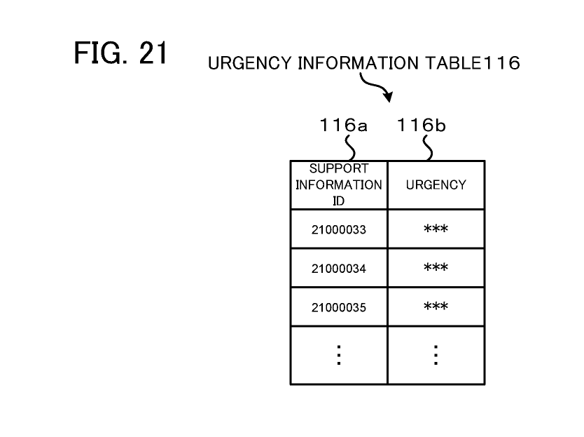

The urgency information table 116 stores urgency information of a support information record, which is stored in the support information table 111. To be specific, for example, as illustrated in FIG. 21 (a diagram illustrating an example of a configuration of the urgency information table 116), the urgency information table 116 stores, for each of the support information, an urgency information record in which a support information ID 116a and an urgency 116b are associated with each other. The support information 1D 116a is identification information of support information associated with the urgency information. The urgency 116b is urgency of a response to an event in relation to the support information associated with the urgency information. A range in which the urgency 116b can be taken is set to, for example, 0 (urgency is low) to 1 (urgency is high). A value indicating that it is unnecessary to respond to an event may be set to the urgency 116b.

A description will be given returning to FIG. 20. A search unit 102C searches and specifies a support information record that meets a set condition from the support information table 111, and searches and specifies an urgency information record associated with the specified support information record from the urgency information table 116.

An output control unit 103C outputs support information and the urgency thereof based on the support information record and the urgency information record associated with the support information specified by the search unit 102C at the time of outputting content of the support information record, for example, in Step S113 and Step S115 (see FIG. 6).

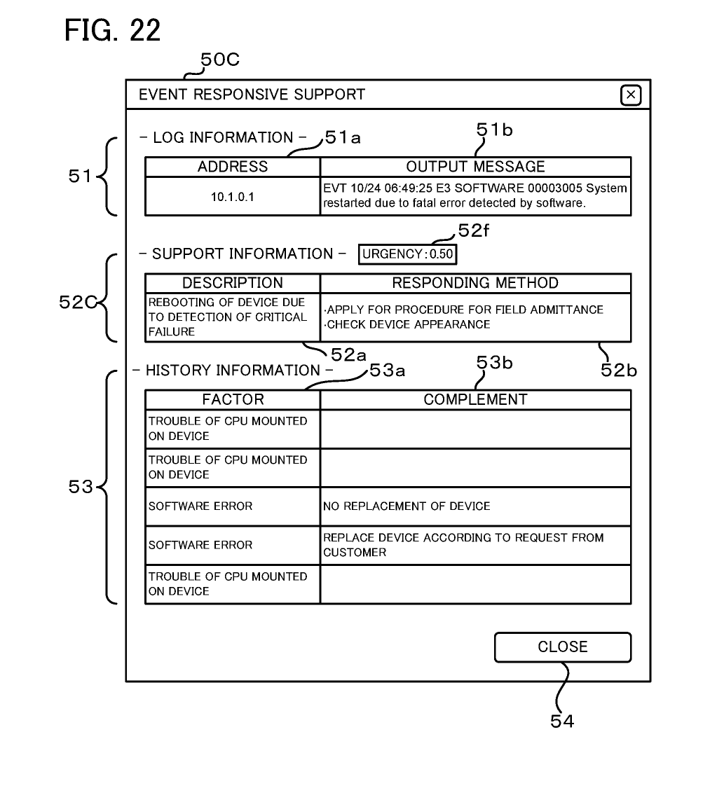

To be specific, the output control unit 103C outputs a UI screen 500, for example, as illustrated in FIG. 22 (a diagram illustrating an example of the UI screen 50C that outputs the urgency). The output control unit 103C acquires the urgency 116b specified by the search unit 102C and outputs the urgency 116b to a support information area 52C as urgency 52f. Incidentally, when the value indicating that it is unnecessary to respond to the event is set to the urgency 116b, the output control unit 103C may output a message, which indicates it is unnecessary to respond to the event, via the output unit 120 or the communication device 140.

A description will be given returning to FIG. 20. The output control unit 103C outputs support information and the urgency thereof based on the support information record and the urgency information record associated with the support information in, for example, Step S205 (see FIG. 8), Step S305 (see FIG. 9), and Step S413 (see FIG. 10) at the time or receiving edit of content of the support information record. An input control unit 104B receives edit of the urgency.

An information generation unit 105C registers an urgency information record associated with a registered support information record in the urgency information table 116 at the time of registering the support information record in the support information table 111, for example, in Step S123 (see FIG. 6). To be specific, the information generation unit 105C adds a new urgency information record to the urgency information table 116. In addition, the support information ID 111a of the registered support information record is set to the support information ID 116a. Setting is not performed on the urgency 116b. In addition, when the urgency is edited, the information generation unit 1050 updates an urgency information record by setting the edited urgency to the urgency 116b of the urgency information record.

The third modification example has been described as above. According to the present modification example, the urgency of support information is displayed together with the support information, and thus, the user can respond to the event upon consideration of the urgency of the support information. If the urgency is high, the user can determine, for example, whether it is necessary to raise priority of the response to the event the like.

Incidentally, any two or more of the first embodiment, and the respective modification examples of the present invention described above may be combined with each other. In addition, the first embodiment, and the respective modification examples of the present invention described above have been provided to illustrate a gist and a scope of the present invention, and the invention is not limited thereto. It is a matter of course that a number of substitutes, corrections, and modification examples can be made by a person skilled in the art.

For example, the control unit 100 may count, for each user, the number of times that the user registers a support information record or the number of times that the support information record registered by the user is used (for example, the number of times that the support information record is output in the search process or the output process), and output the counted number of times to a personnel assessment system. In this manner, the personnel assessment system can assess contribution of the user in relation to support information based on the number of times output from the event responsive support device 1 or use such assessment for comprehensive personnel assessment with resect to the user. In addition, a fact that the user's contribution in relation to the support information is reflected on the assessment on the user serves as an incentive that increases the number of support information or improves the quality of support information. Of course, the control unit 100 may asses the user's contribution in relation to the support information or use the assessment for comprehensive personnel assessment with respect to the user.

In addition, for example, the control unit 100 may calculate, for each user, an average value, a maximum value or a minimum value of reliability of a support information record registered by the user, and output the calculated reliability to a personnel assessment system. In this manner, the personnel assessment system can assess contribution of the user in relation to support information based on the reliability output from the event responsive support device 1 or use such assessment for comprehensive personnel assessment with respect to the user. In addition, a fact that the user's contribution in relation to the support information is reflected on the assessment on the user serves as an incentive that increases the number of support information or improves the quality of support information. Of course, the control unit 100 may asses the user's contribution in relation to the support information or use the assessment for comprehensive personnel assessment with respect to the user.

In addition, a link or a command, which is configured to execute a responding method or a complement, maybe set to the responding method 111g or the complement 112f, for example. In this manner, the user can more easily respond to the event by a clicking operation or the like.

### REFERENCE SIGNS LIST

1 event responsive support device
2 monitoring target device
3 network
10 network system
40 computer
41 CPU
42 memory
43 external storage device
44 communication I/F
45 input device
46 output device
47 media I/F
50 UI screen
log information area
51a address
51b output message
52 support information area
52a description
52b responding method
52c reliability
52d difficulty
52e advice
52f urgency
53 history information area
53a factor
53b complement
54 close button
60 UI screen.
61 support information registration button
62 support information approval button
63 support information search button
64 support information edit button
65 close button
100 control unit.
101 monitoring unit
102 search unit
103 output control unit
104 input control unit
105 information generation unit
106 notification unit
107 reliability calculation unit
110 storage unit
111 support information table
11a support information 1D
111b system name
111c address
111d time zone
111e character string
111f description
111g responding method
111h registration person ID
111i status
112 history information table
112a history information ID
112b response data and time
112c responder ID
112d support information ID
112e factor
112f complement
112g status
113 reliability information, table
113a support information ID
113b reliability
114 difficulty information table
114a support information ID
114b difficulty
115 user level information table
115a user ID
115b level
116 urgency information table
116a support information ID
116b urgency
120 output unit
130 input unit
140 communication device

1. An event responsive support device that supports a response to an event occurring in a monitoring target device, the device comprising:
a support information storage unit configured to store support information including information to specify log information and a responding method to an event associated with the log information;
a history information storage unit configured to store, in association with each of the support information, history information including history of the responding method of the support information that has been output and complementary information with respect to the responding method of the support information in the history;
a monitoring unit configured to monitor log information of the monitoring target device; and
an output unit configured to specify support information associated with the log information of the monitoring target device received by the monitoring unit, from the support information storage unit and acquire the responding method from the specified support information, specify history information, associated with the specified support information, from the history information storage unit and acquire the complementary information from the specified history information, and output the acquired responding method and complementary information.

2. The event responsive support device according to claim 1, further comprising:
a generation unit configured to add history information to the history information storage unit when the support information associated with the log information of the monitoring target device is specified by the output unit, and associate the history information with the specified support information; and
an input unit configured to receive input of information to set the complementary information of the history information added by the generation unit, and set the information to the complementary information.

3. The event responsive support device according to claim 2, wherein
the generation unit adds support information to the support information storage unit when the support information associated with the log information of the monitoring target device is not specified by the output unit, and sets information to specify the log information of the monitoring target device to the support information, and
the input unit receives input of information, which is set to a responding method of the support information added by the generation unit, and sets the responding method.

4. The event responsive support device according to claim 3, wherein
the input unit receives approval with respect to the support information or the history information added to the support information storage unit or the history information storage unit by the generation unit, and
the output unit output the responding method of the approved support information or the complementary information of the approved history information.

5. The event responsive support device according to claim 1, further comprising
a reliability information storage unit configured to store reliability information indicating reliability of the support information in association with each of the support information stored in the support information storage unit,
wherein the output unit acquires reliability information associated with the specified support information from the reliability information storage unit, and outputs the acquired reliability information together with the responding method.

6. The event responsive support device according to claim 5, further comprising
a reliability calculation unit configured to calculate the reliability of the support information based on the number of history information associated with the support information, and set the calculated reliability to the reliability information stored in the reliability information storage unit.

7. The event responsive support device according to claim 5, wherein
the output unit determines whether the reliability of the support information is equal to or lower than a predetermined threshold, and outputs a message to encourage a review the support information having the reliability equal to or lower than the predetermined threshold.

8. The event responsive support device according to claim 1, further comprising
a difficulty information storage unit configured to store difficulty information indicating a difficulty of the responding method of the support information in association with each of the support information stored in the support information storage unit,
wherein the output unit acquires difficulty information associated with the specified support information from the difficulty information storage unit, and outputs the acquired difficulty information together with the responding method.

9. The event responsive support device according to claim 8, further comprising
a level information storage unit configured to store information indicating a response ability level of a user in association with each of the users,
wherein the output unit acquires level information of a user as an output destination of the responding method from the level information storage unit, and determines and outputs advice content based on the acquired difficulty information and level information.

10. The event responsive support device according to claim 1, further comprising
an urgency information storage unit configured to store urgency information indicating urgency of a response to the event based on the support information in association with each of the support information stored in the support information storage unit,
wherein the output unit acquires urgency information associated with the specified support information from the urgency information storage unit, and outputs the acquired urgency information together with the responding method.

11. An event responsive support method in an event responsive support device that supports a response to an event occurring in a monitoring target device,
the event responsive support device includes:
a support information storage unit configured to store support information including information to specify log information and a responding method to an event associated with the log information; and
a history information storage unit configured to store, in association with each of the support information, history of the responding method of the support information that has been output and complementary information with respect to the responding method of the support information in the history,
the event responsive support method comprising:
a monitoring step of monitoring log information of the monitoring target device; and
an output step of specifying support information, associated with the log information of the monitoring target device received in the monitoring step, from the support information storage unit and acquiring the responding method from the specified support information, specifying history information associated with the specified support information from the history information storage unit and acquiring the complementary information from the specified history information, and outputting the acquired responding method and complementary information.

12. (canceled)
